(19) United States
(12) Patent Application Publication
(10) Pub. No.: US 2025/0358371 A1
(43) Pub. Date: Nov. 20, 2025

(54) POWER SHARING FOR SMART DOORBELL HEAD AND CHIME CONTROLLER

(71) Applicant: Roku, Inc., San Jose, CA (US)

(72) Inventors: Gregory Mack Garner, Key Colony Beach, FL (US); Robert Caston Curtis, Napa, CA (US); Dustin John Verhoeve, Santa Cruz, CA (US); Bruce Benson, Yaxley (GB)

(73) Assignee: Roku, Inc., San Jose, CA (US)

(21) Appl. No.: 19/037,613

(22) Filed: Jan. 27, 2025

Related U.S. Application Data
(60) Provisional application No. 63/648,791, filed on May 17, 2024.

(51) Int. Cl. H04M 11/02; G08B 3/10; H02J 7/06; H04N 7/18

(52) U.S. Cl. CPC H04M 11/025; G08B 3/10; H04N 7/186; H02J 7/06

(57) ABSTRACT

A system is described and includes a power source for generating alternating current (AC) power; a doorbell device connected to the power source, wherein the doorbell device comprises a camera and a pushbutton; a chime controller connected to the power source and to the doorbell device, the chime controller configured to activate a chime in response to depression of the pushbutton, the chime controller including a rechargeable battery for powering the chime; and circuitry configured to provide a first portion of the AC power generated by the power source to the doorbell device, the first portion sufficient for powering the camera, and a second portion of the power from the power source to the chime controller, the second portion sufficient for charging the battery.

### CROSS-REFERENCE TO RELATED APPLICATION

This application claims the benefit of and priority to U.S. Patent Application Ser. No. 63/648,791, filed May 17, 2024, entitled “POWER SHARING FOR SMART DOORBELL HEAD AND CHIME CONTROLLER,” which is incorporated herein by reference in its entirety.

### TECHNICAL FIELD

This disclosure relates generally to smart doorbell systems, and more specifically, to techniques for sharing power between a doorbell head and a chime controller of such systems.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a block diagram of an example smart doorbell system according to some embodiments of the disclosure.

FIG. 2 illustrates a block diagram of an example doorbell head of the smart doorbell system of FIG. 1 according to some embodiments of the disclosure.

FIG. 3 illustrates a block diagram of an example chime controller of the smart doorbell system of FIG. 1 according to some embodiments of the disclosure.

FIG. 4 illustrates an example circuit for sharing power between the doorbell head and the chime controller of the smart doorbell system of FIG. 1 according to some embodiments of the disclosure.

FIG. 5 illustrates another example circuit for sharing power between the doorbell head and the chime controller of the smart doorbell system of FIG. 1 according to some embodiments of the disclosure.

FIG. 6 illustrates another example circuit for sharing power between the doorbell head and the chime controller of the smart doorbell system of FIG. 1 according to some embodiments of the disclosure.

FIGS. 7 and 8 illustrate yet another example circuit for sharing power between the doorbell head and the chime controller of the smart doorbell system of FIG. 1 according to some embodiments of the disclosure.

FIG. 9 illustrates a flow diagram of example operations performed by the smart doorbell system of FIG. 1 according to some embodiments of the disclosure.

FIG. 10 illustrates a manner in which an AC waveform provided by the transformer of the smart doorbell system of FIG. 1 may be split between the doorbell head and the chime controller when the chime is on and when the chime is off, respectively, according to some embodiments of the disclosure.

FIG. 11 illustrates another example circuit for sharing power between the doorbell head and the chime controller of the smart doorbell system of FIG. 1 as shown in FIG. 10 according to some embodiments of the disclosure.

FIG. 12 illustrates another example circuit for sharing power between the doorbell head and the chime controller of the smart doorbell system of FIG. 1 according to some embodiments of the disclosure.

FIG. 13A illustrates another example circuit for sharing power between the doorbell head and the chime controller of the smart doorbell system of FIG. 1 according to some embodiments of the disclosure.

FIG. 13B illustrates another example circuit for sharing power between the doorbell head and the chime controller of the smart doorbell system of FIG. 1 according to some embodiments of the disclosure.

FIG. 14 illustrates another example circuit for sharing power between the doorbell head and the chime controller of the smart doorbell system of FIG. 1 according to some embodiments of the disclosure.

FIG. 15 illustrates a block diagram of an example computing device, according to some embodiments of the disclosure.

### DETAILED DESCRIPTION

### Overview

A doorbell is a signaling device typically placed near an entrance to a structure. When a user depresses a doorbell pushbutton, a chime located inside the structure rings, alerting the occupant to the presence of the user. Modern doorbells are electric, operated by a pushbutton switch. Current doorbells, often referred to as “smart” doorbells, may incorporate intercoms and cameras to increase security of the structure.

An analog doorbell circuit includes an AC power source (often implemented as a low voltage AC transformer) installed within the structure. One side of the power source goes through the doorbell pushbutton comprising a mechanical switch and the return wire from switch goes to a chime, which may be implemented using an electromagnet that pulls a mechanical lever to strike a bell. The output of the chime is connected to the transformer. Accordingly, current doorbell circuits comprise a loop, with the doorbell switch and chime connected in series.

Smart doorbells include electronics that must be powered. In some conventional embodiments, a relay board is installed on the chime that removes the chime from the aforementioned loop so that line power from the AC transformer may be used to power the doorbell circuitry. When a user presses the doorbell pushbutton, the chime must be returned to the circuit, which removes power from the camera. One way in which this has been addressed is to include a battery in the doorbell head to power the camera for the time period in which line power is being diverted to the chime. Including a battery in the doorbell head is costly and also subjects the battery to environmental conditions, such as temperature extremes, that may negatively impact battery performance over time. Additionally, including a battery in the doorbell head requires the doorbell head to be sufficiently large to accommodate a sufficiently large battery.

It would therefore be preferable to remove the battery from the doorbell head and include it inside the structure on which the doorbell head is installed, e.g., collocated with a chime controller for controlling the chime in a smart doorbell system. In such a configuration, the battery would be used to ring the chime rather than to power the camera.

Alternatively, in some embodiments, the battery may be eliminated altogether and a supercapacitor incorporated into the doorbell head. The existing chime controller power supply may be harnessed and divided between the chime controller and the doorbell head in such a manner as to support both a fully operational smart doorbell and a normally operating chime.

Typical doorbell chimes operate at low voltage; e.g., between approximately 8 and 24 volts AC (VAC). The doorbell head itself typically requires approximately 5 volts, for example, for powering electronic components thereof (e.g., camera, sensors, microphone, etc.). In full operation, the doorbell head would need to continuously receive approximately 5 volts power; the doorbell head will typically include a power management system for stepping down voltage for save operation in conjunction with sensors and other electronic components of the doorbell head. The voltage requirements of the doorbell head can interfere with normal operation of the chime if insufficient power is available. This issue is addressed by the various embodiments described hereinbelow.

In at least one example embodiment, as will be described in greater detail below, to address the aforementioned issue, the doorbell head may be placed into a low-power mode for the duration of the chime's operation by turning off all sensors as well as discharging a supercapacitor to help power the doorbell head for the approximately 2-3 seconds required by the chime.

### Example Smart Doorbell System

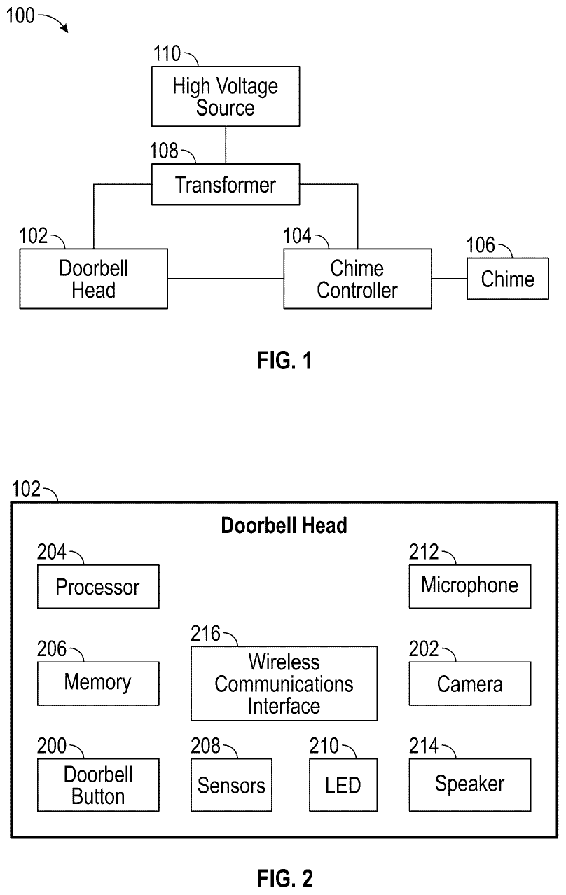

Referring now to FIG. 1, an example smart doorbell system 100 may include a doorbell head 102, which may be disposed on an exterior surface of a structure, and a chime controller 104 disposed within the structure. Chime controller 104 may control operation (e.g., trigger activation) of a chime 106, also disposed within the structure. Both doorbell head 102 and chime controller 104 may be connected to receive line power from an AC power source, which may be implemented as a transformer 108 connected to a high voltage power source 110 of the structure. Referring now to FIG. 2, in particular embodiments, doorbell head 102 may include one or more of a doorbell pushbutton 200 for initiating operation of remote chime 106 in response to depression thereof, a camera 202 for capturing images, a processor 204, and a memory 206 for storing programs executable by the processor 204. Doorbell head 102 may further include a one or more sensors, such as motion sensors, 208, one or more light emitting diodes (LEDs), represented in FIG. 2 by an LED 210, a microphone 212, a speaker 214, and a wireless communications interface 216 (e.g., a wireless transceiver) for communicating data with a remote server over a wireless communications network. A power interface 218 for receiving power from a power source (e.g., transformer 108) may also be included. Doorbell head 102 further includes appropriate circuitry and electronics for enabling communication of signals between the elements illustrated in FIG. 2. It will be recognized that doorbell head 102 may include more or fewer elements than those listed without departing from the spirit or scope of embodiments described herein.

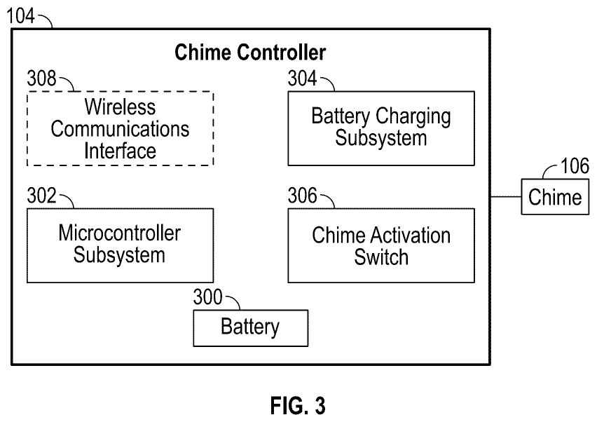

Referring now to FIG. 3, in accordance with features of embodiments described herein, a battery 300 is collocated with the chime controller 104 (i.e., inside the structure) rather than with the doorbell head 102, such that chime controller 104 and chime 106 are powered by battery 300, which is recharged by line power from transformer 108, while doorbell head 102 is powered by the line power from transformer 108. As a result of this design, the enclosure comprising doorbell head 102 can be smaller because it need not include a battery and/or a heating clement for a battery. Additionally, the life of battery 300 can be extended due to the fact that it is protected from potentially extreme temperature fluctuations and other environmental conditions that may negatively impact battery life and performance. In some embodiments, battery 300 may be implemented using a supercapacitor (SC) (or ultracapacitor), which is a high-capacity capacitor with a capacitance that is greater than solid-state capacitors and voltage limit lower than solid-state capacitors. Regardless of implementation, battery 300 may be sized appropriately to ensure that there is enough power to ring chime 106.

In particular embodiment, and as will be described in greater detail below, in addition to battery 300 chime controller 104 may further include one or more of a microcontroller subsystem 302, a battery charging subsystem 304, a chime activation switch 306, an optional wireless communications interface 308, and a power interface 310.

It will be recognized that in particular embodiments, the amount of current required by doorbell head 102 to power circuitry thereof, including camera 202, may be different (e.g., greater) than that required by chime controller to keep battery 300 charged and power the electronics thereof. It will further be recognized that, in particular embodiments, the amount of current required by each of the devices 102, 104, may vary over time. Because devices 102, 104, are connected in series, additional power sharing circuitry may be required for ensuring that each device is provided with sufficient operational current at all times.

### First Example Circuit for Power Sharing in a Smart Doorbell System

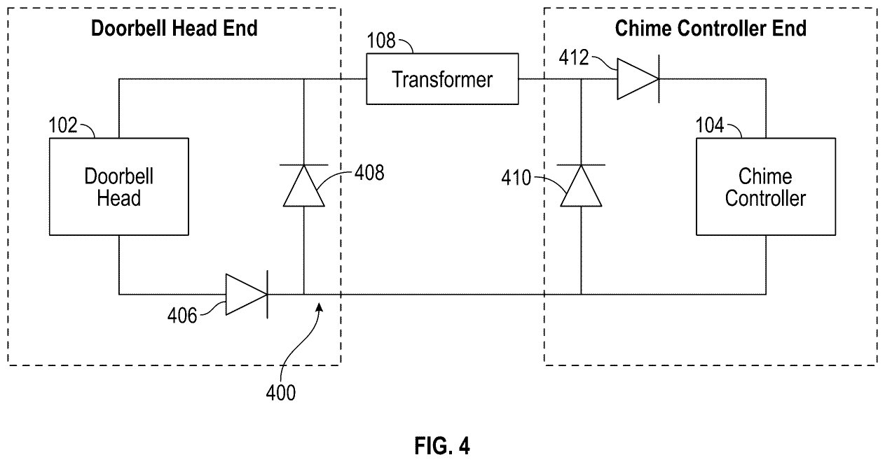

Referring now to FIG. 4, illustrated therein is an example circuit 400 for sharing power from transformer 108 between doorbell head 102 (for powering camera 202 and other circuitry of doorbell head 102) and chime controller 104 (for recharging battery and/or providing nominal power to other circuitry of chime controller 104). As shown in FIG. 4, circuit 400 comprises diodes 406-412 for directing positive half cycles to one of the devices and negative half cycles to the other device. Circuit 400 is problematic in that it is polarity sensitive. If circuit 400 is installed incorrectly (i.e., backwards), the transformer 108 will be dead shorted in one direction and devices 102, 104, will be in series in the other direction; in other words, system 100 will not work. Additionally, circuitry 400 does not support line power signaling from doorbell head 102 to chime controller 104 to trigger activation of the chime responsive to depression of doorbell pushbutton. Still further, depending on the size of the transformer 108, circuit 400 may make too little power available to doorbell head 102 to power the camera while making more power than necessary available to chime controller 104 for charging battery 300.

A possible solution to the issue of the polarity sensitivity of circuit 400 may be to employ a pair of silicon controlled rectifiers (SCRs) in circuit 400. In operation, a microcontroller could determine which way circuit 400 was installed (e.g., by an end-user/consumer) and then only turns on the one of the SCRs that is wired in the proper direction.

### Second Example Circuit for Power Sharing in a Smart Doorbell System

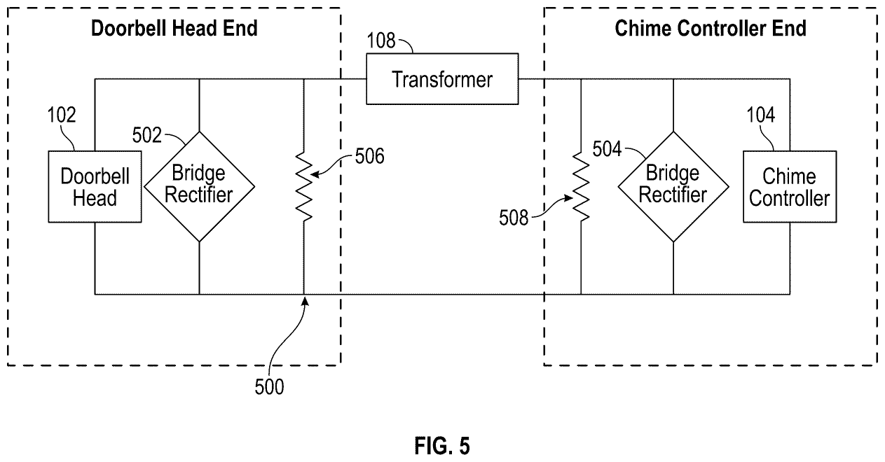

Referring now to FIG. 5, illustrated therein is an example circuit 500 for sharing power from transformer 108 between doorbell head 102 (for powering camera 202 and other circuitry of doorbell head 102) and chime controller 104 (for recharging battery and/or providing nominal power to other circuitry of chime controller 104). As shown in FIG. 5, circuit 500 comprises full wave bridge rectifiers 502, 504, and variable resistors 506, 508, across the devices 102, 104. Circuit 500 addresses the first deficiency described above with respect to circuit 400; in particular, resistors 506, 508, ensure that there is a voltage drop that devices 102, 104, can tap into and rectifiers 502, 504, harvest the power, assuming the voltage is greater than two diode drops. As each device 102, 104, draws more power, the voltage drop across the respective resistor 506, 508, decreases. Circuit 500 ensures that there is startup power available to the circuitry on each device 102, 104. If one of the devices 102, 104, does not require as much power, it can switch in a smaller resistor (e.g., close to 0 ohms) to shunt most of the power to the other one of the devices. Conversely, if one of the devices 102, 104, needs more power, it can switch the resistor 506, 508, on its end out entirely, so that all of the power flows through the bridge rectifier on that end. Also, each device 102, 104, could use the voltage drop across the respective resistor 506, 508, to sense how much voltage drop is on the other end, giving the doorbell head 102 a way to signal the chime controller 104 to activate the chime 106. Modulating resistor 506 in a particular, recognized, pattern enables doorbell head 102 to signal chime controller 104 to that the chime 106 should be activated. Circuit 500 thereby avoids the use of the simpler mechanism of just directly shorting out resistor 506 to signal chime controller 104 and enables doorbell head 102 to continue to receive power while signaling that chime 106 should be activated. It will be recognized that circuit 500 is a variation of a voltage division circuit in which both devices 102, 104, can sense the power used by the other device and to control power used available to the device itself.

It will be recognized that one way to create a variable resistor is to use a metal-oxide semiconductor field effect transistor (MOSFET) to act as the resistor; however, this requires that both ends turn on the MOSFETs at AC power on, which is difficult or impossible. An alternative is to place a MOSFET across a resistor; in this manner, if the MOSFET is turned off, the resistor dominates. Turning on the MOSFET can make the resistor be lower, allowing the other side to draw more power. At AC reset time, both MOSFETS on both ends are off, so that both ends receive about half the power, fi the resistors are equal in vale. If one side (e.g., doorbell head 102) needs more power as a default, the resistor on the other side (e.g., chime controller 104) could be smaller, thereby limiting how much power is applied to the side with the lower resistor. Alternatively, a MOSFET may be included only on the end that draws less power over time (e.g., chime controller 104).

Circuit 500 may be further modified by making bridge rectifiers 502, 504, controllable. In particular, the default could be each bridge rectifier 502, 504, being on 100% of the time, but after the processor starts up and has enough power, it can selectively take as much power as it wants by pulse width modulating the bridge rectifier. In this embodiment, control of the bridge rectifiers on both sides needs to be carefully coordinated.

### Third Example Circuit for Power Sharing in a Smart Doorbell System

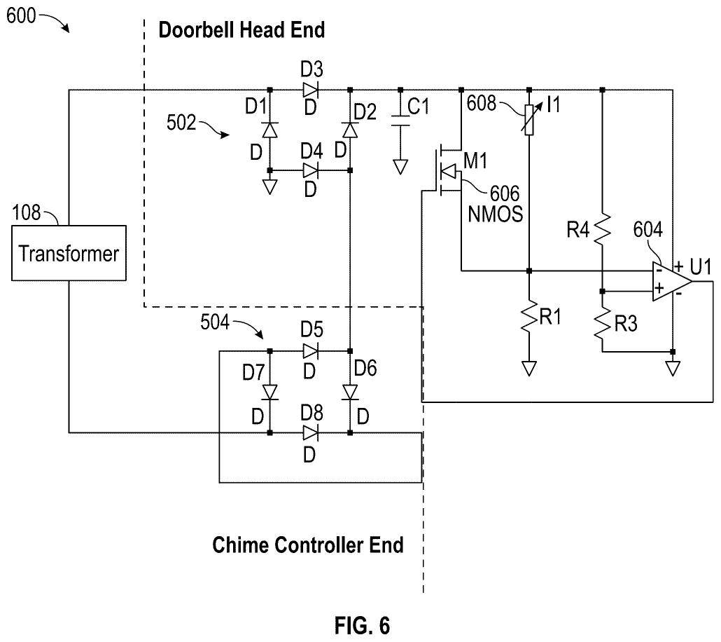

Referring now to FIG. 6, illustrated therein is an example circuit 600 for sharing power from transformer 108 between doorbell head 102 (for powering camera 202 and other circuitry of doorbell head 102) and chime controller 104 (for recharging battery and/or providing nominal power to other circuitry of chime controller 104). As shown in FIG. 6, circuit 600 comprises full wave rectifiers 502, 504, on doorbell head and chime controller. Primary device (e.g., doorbell head 102) can take as much power as it requires; however, if it goes to sleep and takes too little current, a sub-circuit including an operational amplifier (opamp) 604 and field effect transistor (FET) 606 guarantees a minimum amount of current will flow to secondary device (e.g., chime controller). In this embodiment, chime controller 104 is mostly a passthrough, but can take a small amount of power for powering itself and recharging battery.

As shown in FIG. 6, variable load 608 represents doorbell head 102 (particularly camera 202) and associated circuitry. In particular embodiments, when current to variable load 608 is above 100 mA, FET 606 is off; when current to variable load 608 drops below 100 mA, FET 606 turns on to guarantee that a minimum current passes to chime controller 104.

### Fourth Example Circuit for Power Sharing in a Smart Doorbell System

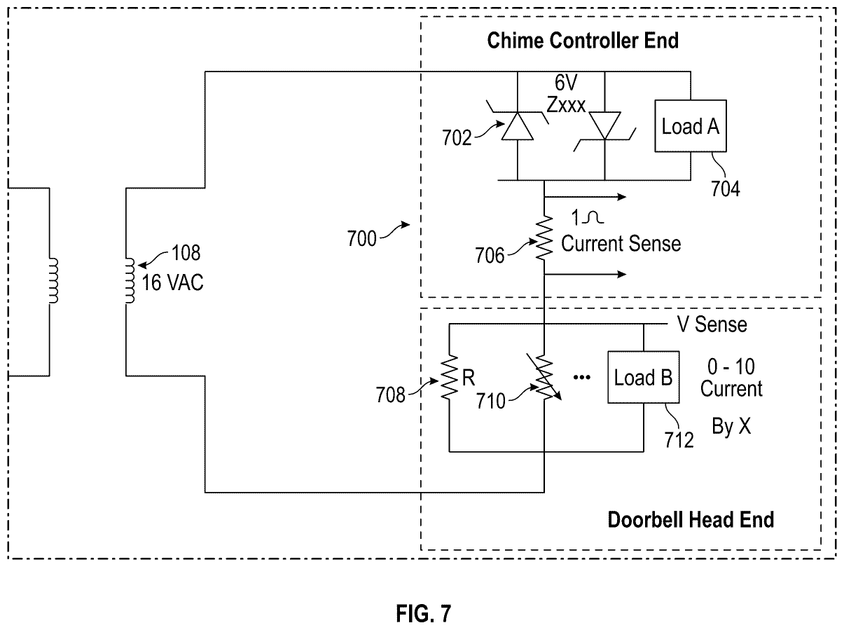

Referring now to FIG. 7, illustrated therein is an example circuit 700 for sharing power from transformer 108 between doorbell head 102 (for powering camera 202 and other circuitry of doorbell head 102) and chime controller 104 (for recharging battery and/or providing nominal power to other electronics of chime controller 104). As shown in FIG. 7, circuit 700 includes a Zener diode pair 702 configured to support a specified maximum voltage drop across a load A 704 comprising chime controller 104. In a particular embodiment, transformer 108 may output 16 VAC and maximum voltage drop across load A 704, as maintained by Zener diode pair 702, may be 6 VAC. Load A 704 may draw current necessary to recharge the battery for powering the chime and for powering chime controller electronics. A small current sense resistor 706 is provided for enabling current between chime controller end and doorbell head end to be sensed. In a particular embodiment, a resistance of resistor 706 may be 0.1 ohms.

Doorbell head end includes a resistor 708 in parallel with a variable resistance device 710 having a resistance value controlled by a load B 712, which comprises doorbell head 102. In particular, resistance value of device 710, which may be implemented using a MOSFET, may be controlled by processor 204 of doorbell head 102. It will be recognized that a voltage across devices 708, 710, and 712 will be equal to transformer voltage (e.g., 16 VAC) less the voltage across Zener diode pair 702 (e.g., 6 VAC). In the illustrated embodiment, voltage across devices 708, 710, and 712 is 10 VAC. In particular embodiments, microcontroller circuitry in either or both of loads A and B may be used to detect whether transformer 108 is too small to provide sufficient power for chime controller and/or doorbell head circuitry and signal a user interface or other system to alert user to upgrade transformer 108.

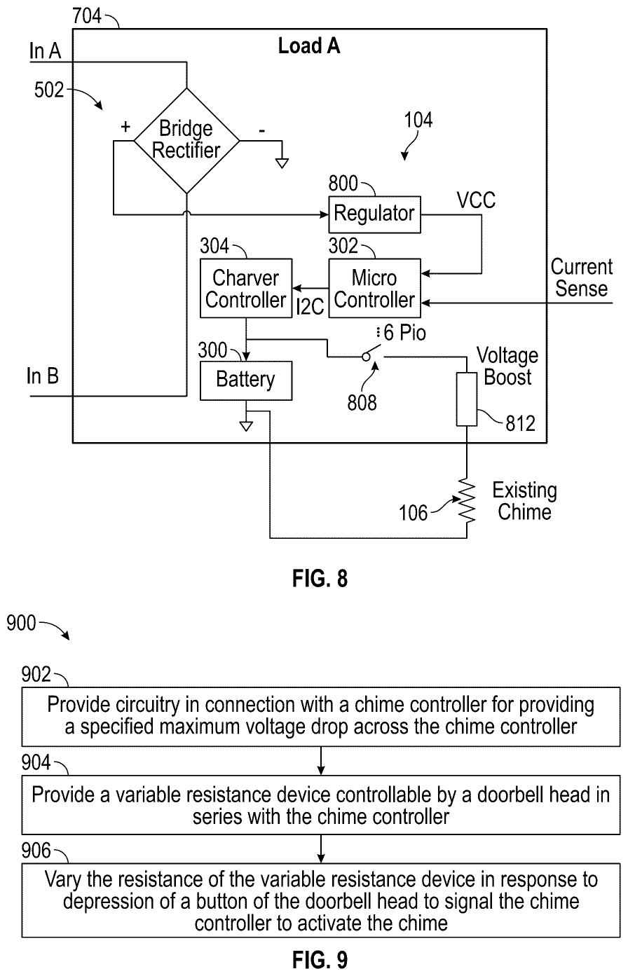

FIG. 8 is a block diagram illustrating an example of circuitry and devices comprising load A 704. As shown in FIG. 8, load A 704 includes bridge rectifier 502 connected to chime controller 104, which includes a voltage regulator 800 for providing Vcc to microcontroller subsystem 302. A current sense signal from current sense resistor 706 is provided to microcontroller subsystem 302 for use determining whether to activate chime 106 by closing switch 808 to provide power to chime 106 from battery 300. A voltage boost device 812 may be provided for boosting voltage to chime 106 as necessary (e.g., to ensure it rings at a sufficient volume). Microcontroller subsystem 302 further provides signals to charger controller (i.e., battery charging subsystem) 304 to charge battery 300.

In particular embodiments, resistance value of device 710 may be varied at a known rate and/or in a known pattern by load B 712 to signal to microcontroller subsystem 302 of chime controller 104 via current sensor signal (i.e., current through resistor 706) to activate chime 106. In alternative embodiments, signal from doorbell head to chime controller to activate the chime may be provided via radio frequency, Wi-Fi, or other signaling means.

Although a variety of methods of power sharing, or power splitting, have been shown and illustrated above, other methods may be implemented, including but not limited to time division multiplexing, voltage division, transformer splitting (in which each device has a transformer so that there are two transformers in series), active management by one device (in which one device takes some of the power and actively manages how much power is provided to the other device), and active management by both devices (in which each device actively manages how much power it consumes and how much power it provides to the other device). Regardless of the method chosen, it is necessary to make sure that a direct short across the transformer 108 does not occur. Additionally, regardless of what method is employed, there must be a way to communicate from the doorbell head to the chime controller when to activate the chime (e.g., via line power or wirelessly).

### Example Technique for Power Sharing in a Smart Doorbell System

FIG. 9 is a flow diagram 900 of example operations performed in connection with techniques for power sharing in a smart doorbell system, such as the smart doorbell system 100 (FIG. 1), in which a power source, a chime controller, and a doorbell head are connected in series, according to some embodiments of the disclosure. In certain embodiments, one or more of the operations illustrated in FIG. 9 are performed by elements illustrated in one or more of FIGS. 1-8, for example.

In operation 902, circuitry (e.g., Zener diode pair 702) is provided in connection with a chime controller for providing a specified maximum voltage drop across the chime controller. As previously noted, chime controller will derive as much or as little current as needed to power electronics thereof and to charge the battery provided therein.

In operation 904, a variable resistance device (e.g., device 710) controllable by doorbell head (e.g., load B 712) is provided in series with chime controller.

In operation 906, the resistance of variable resistance device is varied (e.g., according to a known pattern) in response to depression of the doorbell head pushbutton to signal to the chime controller (e.g., via current across resistor 706) to activate the chime.

Although the operations of the example method shown in and described with reference to FIG. 9 are illustrated as occurring once each and in a particular order, it will be recognized that the operations may be performed in any suitable order and repeated as desired. Additionally, one or more operations may be performed in parallel. Furthermore, the operations illustrated in FIG. 9 may be combined or may include more or fewer details than described.

### Additional Example Circuits for Power Sharing in a Smart Doorbell System

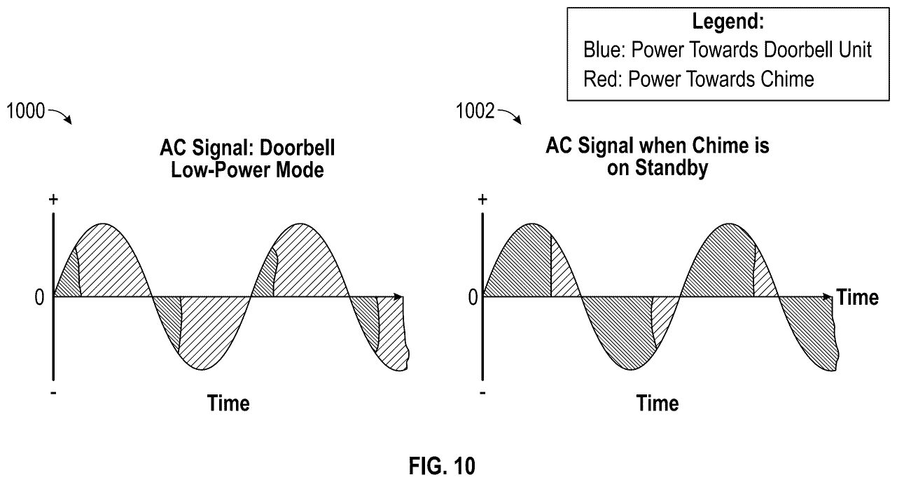

In particular embodiments, the AC signal from transformer 108 (FIG. 1) may be split as illustrated in FIG. 10, with the doorbell head being provided the leading edge (LE) and the chime being provided the trailing edge (TE). Waveform 1000 illustrates division of the AC signal when the doorbell head unit 102 (FIG. 1) is in a low power mode (e.g., when the chime is operating) and waveform 1002 illustrates division of the AC signal when chime controller 104/chime 106 are on standby (i.e., not currently operating).

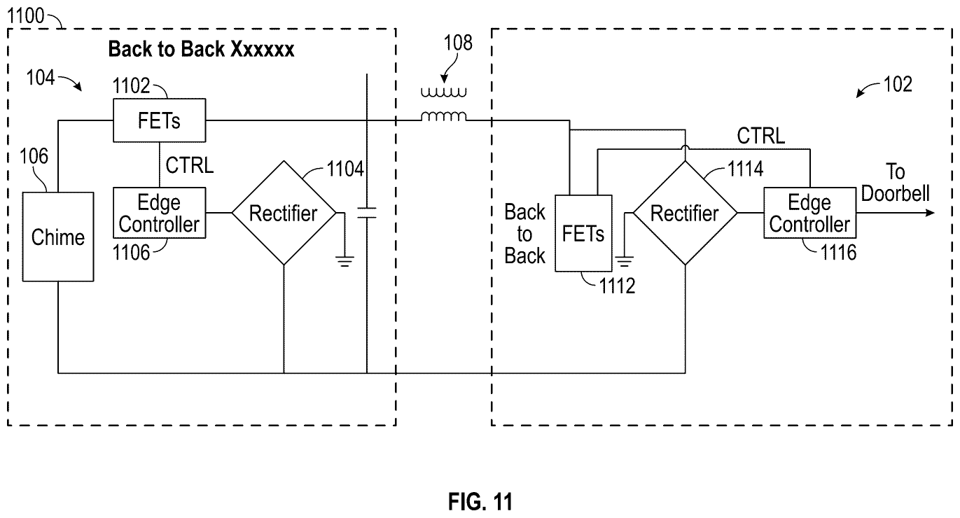

Referring now to FIG. 11, illustrated therein is an example circuit 1100 for sharing power from transformer 108 between doorbell head 102 and chime controller 104 as illustrated in FIG. 10 in accordance with embodiments described herein. As shown in FIG. 11, a chime side of circuit 1100 includes a system of FETs 1102 comprising back-to-back MOSFETs for use as gates to distribute power from rectifier 1104 to chime 106 under the control of an edge controller 1106.

A doorbell head side of circuit 1100 includes a system of FETs 1112 comprising back-to-back MOSFETs for use as gates to distribute power from rectifier 1114 to doorbell head 102 under the control of an edge controller 1116. There will be a need to keep edge controller 1106 powered; therefore, edge controller 1106 will await a signal pulse or current spike when edge controller 1116 puts FETs 1112 into a chime operation mode. Since the AC power provided by transformer 108 may vary from home to home, circuit 1100 relies on the ability of edge controllers 1106, 1116, to read the length of the waveform from transformer 108 and control the ON/OFF cycle of respective FETs 1102, 1112, accordingly. Moreover, to enable communication between edge controllers 1106, 1116, in one implementation, the positive side of AC waveform from transformer 108 is blocked from reaching the chime side during normal operation, with zero-crossing detection being performed within the edge controller 1106 to read any positive-sided spikes as an indication that chime 106 should be turned on. Both edge controllers 1106, 1116, may have a preset time before they return to their normal operating states. It will be recognized that FETs 1102, 1112, may be replaced with solid state relays (SSRs) in particular embodiments without departing from the spirit of the disclosure herein.

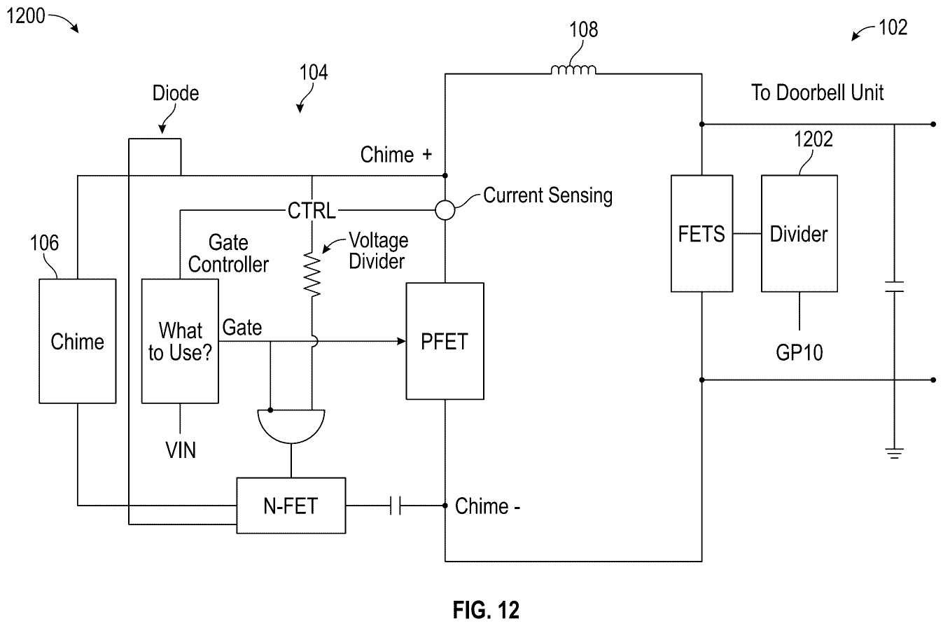

Referring now to FIG. 12, illustrated therein is an example circuit 1200 for sharing power from transformer 108 between doorbell head 102 and chime controller 104 in accordance with embodiments described herein using a dimmer controller 1202 and associated circuitry. As configured in circuit 1200, dimmer controller 1202 awaits a signal indicating the doorbell button has been pressed and provides fast and reliable phase cutting of the AC waveform; the desired phase cut will only need to be set once. Dimmer controller 1202 further provides integrated zero-crossing detection and can handle AC loads without requiring rectification. In circuit 1200, the current that does not go through dimmer controller 1202 remains within the rest of the circuitry (i.e., doorbell head end), thereby eliminating the need to redirect current to the doorbell head end. Moreover, there is no need for an edge controller on the chime side of circuit 1200; the microcontroller only needs to detect when the doorbell button is pressed in order to initiate the chime.

In accordance with features of embodiments described herein, there is a need to keep the doorbell head powered when it is in “low power” mode (i.e., when the chime is active). In addition/alternatively to the methods described hereinabove, this could be performed using a supercapacitor within the doorbell head, which would maintain the desired power in the doorbell head for the approximately 1-3 second duration of the chime. In particular embodiments, the entire AC waveform from the transformer could be dedicated toward the chime end in order to negate any notable changes in audio strength and allow for a simpler circuit design/operation. A cool-down may need to be implemented for limiting how often the chime could be played in order to allow sufficient time for the supercapacitor to be charged. In particular embodiments, sensors in the doorbell head may be rendered inoperable while the chime is in operation in order to increase the lifespan of the supercapacitor.

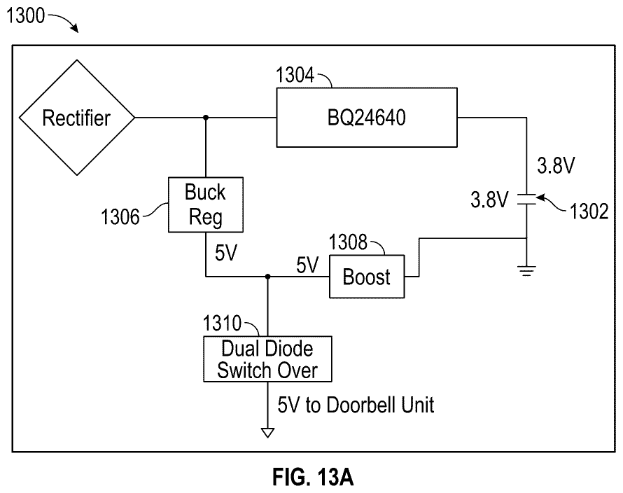

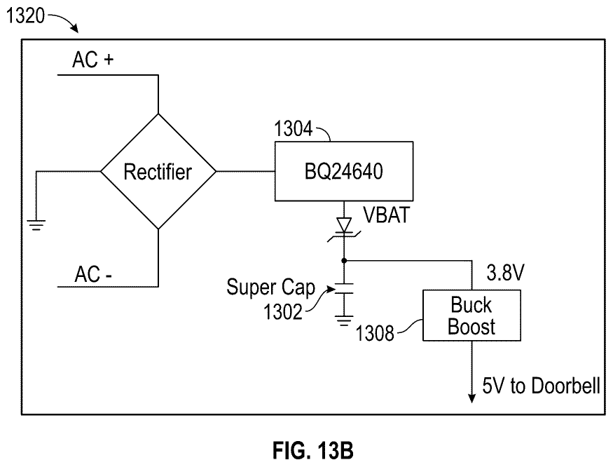

Referring now to FIG. 13A, illustrated therein is an example circuit 1300 for powering a doorbell head side of a smart doorbell system. As shown in FIG. 13, a super capacitor 1302 may be charged using a switched mode supercapacitor charge controller 1304 and associated circuitry, including a buck regulator 1306 for stepping down voltage from the rectifier and a boost regulator 1308 for stepping up the voltage of the supercapacitor. In particular embodiments, charge controller 1304 may be implemented using a BQ24640 charge controller available from Texas Instruments. A dual diode switchover element 1310 is also provided.

In an alternative circuit 1320, as illustrated in FIG. 13B, it is possible to power both supercapacitor 1302 and the doorbell unit by rewiring the VBAT signal of charge controller 1304 to charge both the supercapacitor and lead toward the boost regulator 1308, thereby reducing the need for both power switching and an external voltage regulator (e.g., the buck regulator 1306 (FIG. 13A) and decreasing the number of integrated circuit chips (ICs) needed to implement circuit 1300.

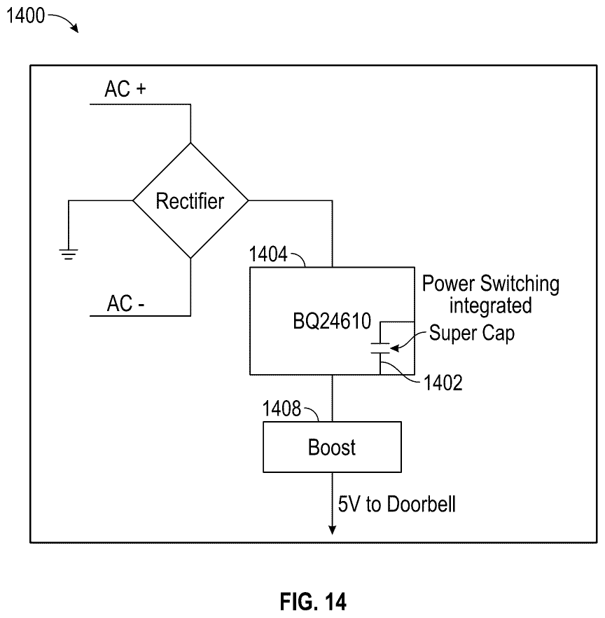

Referring now to FIG. 14, illustrated therein is an example circuit 1400 comprising an alternative to circuit 1300 for powering a doorbell head side of a smart doorbell system. As shown in FIG. 14, a super capacitor 1402 may be charged using a buck battery charge controller 1404 having integrated power switching and associated circuitry, including a boost regulator 1408 for boosting the output of the supercapacitor. In particular embodiments, charge controller 1404 may be implemented using a BQ24610 charge controller available from Texas Instruments.

### Example Processing Device

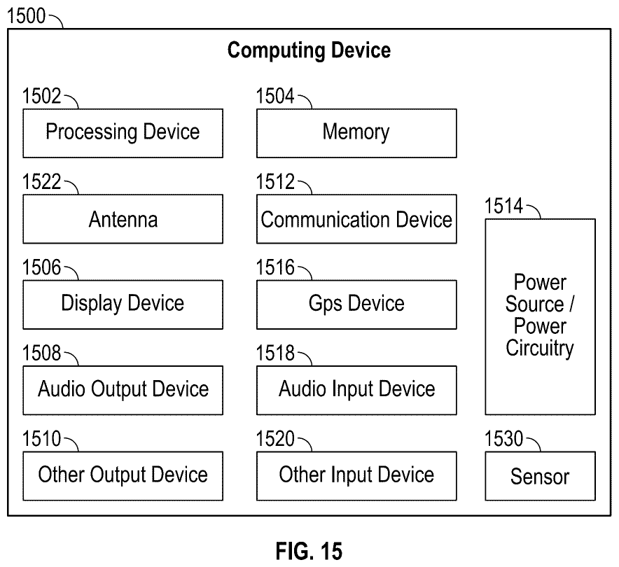

FIG. 15 is a block diagram of an example processing, or computing, device 1500, according to some embodiments of the disclosure. One or more computing devices, such as computing device 1500, may be used to implement the functionalities described with reference to the FIGURES and herein. A number of components are illustrated in the FIGURES as included in the computing device 1500, but any one or more of these components may be omitted or duplicated, as suitable for the application. In some embodiments, some or all of the components included in the computing device 1500 may be attached to one or more motherboards. In some embodiments, some or all of these components are fabricated onto a single system on a chip (SoC) die. Additionally, in various embodiments, the computing device 1500 may not include one or more of the components illustrated in FIG. 15, and the computing device 1500 may include interface circuitry for coupling to the one or more components. For example, the computing device 1500 may not include a display device 1506, and may include display device interface circuitry (e.g., a connector and driver circuitry) to which a display device 1506 may be coupled. In another set of examples, the computing device 1500 may not include an audio input device 1518 or an audio output device 1508 and may include audio input or output device interface circuitry (e.g., connectors and supporting circuitry) to which an audio input device 1518 or audio output device 1508 may be coupled.

The computing device 1500 may include a processing device 1502 (e.g., one or more processing devices, one or more of the same type of processing device, one or more of different types of processing device). The processing device 1502 may include electronic circuitry that process electronic data from data storage elements (e.g., registers, memory, resistors, capacitors, quantum bit cells) to transform that electronic data into other electronic data that may be stored in registers and/or memory. Examples of processing device 1502 may include a central processing unit (CPU), a graphical processing unit (GPU), a quantum processor, a machine learning processor, an artificial-intelligence processor, a neural network processor, an artificial intelligence accelerator, an application specific integrated circuit (ASIC), an analog signal processor, an analog computer, a microprocessor, a digital signal processor.

The computing device 1500 may include a memory 1504, which may itself include one or more memory devices such as volatile memory (e.g., DRAM), nonvolatile memory (e.g., read-only memory (ROM)), high bandwidth memory (HBM), flash memory, solid state memory, and/or a hard drive. Memory 1504 includes one or more non-transitory computer-readable storage media. In some embodiments, memory 1504 may include memory that shares a die with the processing device 1502. In some embodiments, memory 1504 includes one or more non-transitory computer-readable media storing instructions executable to perform operations described with the FIGURES and herein. Exemplary parts or modules that may be encoded as instructions and stored in memory 1504 are depicted. Memory 1504 may store instructions that encode one or more exemplary parts. The instructions stored in the one or more non-transitory computer-readable media may be executed by processing device 1502. In some embodiments, memory 1504 may store data, e.g., data structures, binary data, bits, metadata, files, blobs, etc., as described with the FIGURES and herein. Exemplary data that may be stored in memory 1504 are depicted. Memory 1504 may store one or more data as depicted.

In some embodiments, the computing device 1500 may include a communication device 1512 (e.g., one or more communication devices). For example, the communication device 1512 may be configured for managing wired and/or wireless communications for the transfer of data to and from the computing device 1500. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 1512 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication device 1512 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 1512 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 1512 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 1512 may operate in accordance with other wireless protocols in other embodiments. The computing device 1500 may include an antenna 1522 to facilitate wireless communications and/or to receive other wireless communications (such as radio frequency transmissions). The computing device 1500 may include receiver circuits and/or transmitter circuits. In some embodiments, the communication device 1512 may manage wired communications, such as electrical, optical, or any other suitable communication protocols (e.g., the Ethernet). As noted above, the communication device 1512 may include multiple communication chips. For instance, a first communication device 1512 may be dedicated to shorter-range wireless communications such as Wi-Fi or Bluetooth, and a second communication device 1512 may be dedicated to longer-range wireless communications such as global positioning system (GPS), EDGE, GPRS, CDMA, WiMAX, LTE, EV-DO, or others. In some embodiments, a first communication device 1512 may be dedicated to wireless communications, and a second communication device 1512 may be dedicated to wired communications.

The computing device 1500 may include power source/power circuitry 1514. The power source/power circuitry 1514 may include one or more energy storage devices (e.g., batteries or capacitors) and/or circuitry for coupling components of the computing device 1500 to an energy source separate from the computing device 1500 (e.g., DC power, AC power, etc.).

The computing device 1500 may include a display device 1506 (or corresponding interface circuitry, as discussed above). The display device 1506 may include any visual indicators, such as a heads-up display, a computer monitor, a projector, a touchscreen display, a liquid crystal display (LCD), a light-emitting diode display, or a flat panel display, for example.

The computing device 1500 may include an audio output device 1508 (or corresponding interface circuitry, as discussed above). The audio output device 1508 may include any device that generates an audible indicator, such as speakers, headsets, or earbuds, for example.

The computing device 1500 may include an audio input device 1518 (or corresponding interface circuitry, as discussed above). The audio input device 1518 may include any device that generates a signal representative of a sound, such as microphones, microphone arrays, or digital instruments (e.g., instruments having a musical instrument digital interface (MIDI) output).

The computing device 1500 may include a GPS device 1516 (or corresponding interface circuitry, as discussed above). The GPS device 1516 may be in communication with a satellite-based system and may receive a location of the computing device 1500, as known in the art.

The computing device 1500 may include a sensor 1530 (or one or more sensors). The computing device 1500 may include corresponding interface circuitry, as discussed above). Sensor 1530 may sense physical phenomenon and translate the physical phenomenon into electrical signals that can be processed by, e.g., processing device 1502. Examples of sensor 1530 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 1500 may include another output device 1510 (or corresponding interface circuitry, as discussed above). Examples of the other output device 1510 may include an audio codec, a video codec, a printer, a wired or wireless transmitter for providing information to other devices, haptic output device, gas output device, vibrational output device, lighting output device, home automation controller, or an additional storage device.

The computing device 1500 may include another input device 1520 (or corresponding interface circuitry, as discussed above). Examples of the other input device 1520 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1500 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device, or a wearable computer system. In some embodiments, the computing device 1500 may be any other electronic device that processes data.

### Selected Examples

Example 1 provides a system including a power source for generating alternating current (AC) power; a doorbell device connected to the power source, in which the doorbell device includes a camera and a pushbutton; a chime controller connected to the power source and to the doorbell device, the chime controller configured to activate a chime in response to depression of the pushbutton, the chime controller including a battery for powering the chime; and circuitry configured to provide a first portion of the AC power generated by the power source to the doorbell device, the first portion sufficient for powering the camera, and a second portion of the power from the power source to the chime controller, the second portion sufficient for charging the battery, the circuitry including at least one device configured to maintain a first maximum voltage drop across the chime controller.

Example 2 provides the system of example 1, in which the circuitry includes bridge rectifiers connected across the chime controller and the doorbell device.

Example 3 provides the system of example 1 or 2, in which the at least one device includes a pair of Zener diodes.

Example 4 provides the system of any one of examples 1-3, in which the circuitry further includes a variable resistance device and in which a resistance of the variable resistance device is controlled by the doorbell device.

Example 5 provides the system of example 4, in which responsive to depression of the pushbutton, the doorbell device varies the resistance of the variable resistance device according to a known pattern.

Example 6 provides the system of example 5, further including a current sense resistor between the chime controller and the doorbell device.

Example 7 provides the system of example 6, in which the chime controller is configured to detect the known pattern via current through the current sense resistor.

Example 8 provides the system of example 7, in which the chime controller is configured to activate the chime in response to detecting the known pattern.

Example 9 provides the system of any one of examples 1-8, in which the variable resistance device includes a metal-oxide semiconductor field effect transistor (MOSFET).

Example 10 provides the system of any one of examples 1-9, in which the chime controller includes a voltage booster between the battery and the chime.

Example 11 provides the system of any one of examples 1-10, in which the power source, the doorbell device, and the chime controller are connected in series.

Example 12 provides the system of any one of examples 1-11, in which the power source and the chime controller are located inside a structure and the doorbell device is located outside the structure.

Example 13 provides a system including a transformer for generating power from a high voltage power source; a doorbell device connected to the power source, in which the doorbell device includes a camera and a pushbutton; a chime controller connected to the power source and to the doorbell device, the chime controller configured to activate a chime in response to depression of the pushbutton, the chime controller including a battery for powering the chime; and circuitry associated with the doorbell device to maintain at least a minimum current through the doorbell device to the chime controller, in which the minimum current is sufficient to power circuitry of the chime controller and to recharge the battery.

Example 14 provides the system of example 13, in which the circuitry a metal-oxide semiconductor field effect transistor (MOSFET) and an operational amplifier connected the camera.

Example 15 provides the system of example 14, in which the minimum current flows through the MOSFET when the camera is in a standby mode.

Example 16 provides the system of any one of examples 13-15, in which responsive to depression of the pushbutton, the doorbell device signals the chime controller to connect the chime to the battery.

Example 17 provides the system of example 16, in which the signaling is accomplished via a wireless communication protocol.

Example 18 provides a method of operating a smart doorbell system including a chime controller, a doorbell device, and a transformer connected in series, the method including providing at least one device in connection with the chime controller configured to providing a specified maximum voltage drop across the chime controller; providing a variable resistance device having a resistance controllable by the doorbell device in series with the chime controller; varying the resistance according to a known pattern in response to depression of a pushbutton of the doorbell device; detecting by the chime controller the varied resistance and activating a chime associated with the chime controller.

Example 19 provides the method of example 18, in which the detecting is performed by detecting a current through a current sense resistor provided between the chime controller and the doorbell device.

Example 20 provides the method of example 18 or 19, in which the at least one device includes a pair of Zener diodes.

Example 21 provides a system comprising a transformer for generating a power signal from a high voltage power source; a doorbell device connected to the transformer, in which the doorbell device comprises a camera, at least one sensor, and a pushbutton; a chime controller connected to the transformer and to the doorbell device, the chime controller configured to activate a chime in response to depression of the pushbutton; and circuitry associated with the doorbell device for charging a supercapacitor from the power generated by the transformer, the supercapacitor configured to power the camera while the chime is activated.

Example 22 provides the system of example 21, in which the circuitry comprises a charge controller for charging the supercapacitor.

Example 23 provides the system of example 22, in which the circuitry further comprises a rectifier for rectifying the power signal from the transformer and a buck regulator for regulating a voltage of the rectified power signal.

Example 24 provides the system of any of any one of examples 21-22, in which the circuitry further comprises a boost regulator for boosting a voltage of the supercapacitor.

Example 25 provides the system of any one of examples 20-24, in which the at least one sensor is deactivated while the chime is activated.

### Variations and Other Notes

The above paragraphs provide various examples of the embodiments disclosed herein.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials, and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the above detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for case of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the above detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device that comprises a list of elements is not necessarily limited to only those elements but may include other elements not expressly listed or inherent to such method, process, or device. Also, the term “or” refers to an inclusive “or” and not to an exclusive “or.”

The systems, methods, and devices of this disclosure each have several innovative aspects, no single one of which is solely responsible for all desirable attributes disclosed herein. Details of one or more implementations of the subject matter described in this specification are set forth in the description and the accompanying drawings.

What is claimed is:

1. A system comprising:
a power source for generating alternating current (AC) power;
a doorbell device connected to the power source, wherein the doorbell device comprises a camera and a pushbutton;
a chime controller connected to the power source and to the doorbell device, the chime controller configured to activate a chime in response to depression of the pushbutton, the chime controller including a battery for powering the chime; and
circuitry configured to provide a first portion of the AC power generated by the power source to the doorbell device, the first portion sufficient for powering the camera, and a second portion of the AC power from the power source to the chime controller, the second portion sufficient for charging the battery, the circuitry comprising at least one device configured to maintain a first maximum voltage drop across the chime controller.

2. The system of claim 1, wherein the circuitry comprises bridge rectifiers connected across the chime controller and the doorbell device.

3. The system of claim 1, wherein the at least one device comprises a pair of Zener diodes.

4. The system of claim 1, wherein the circuitry further comprises a variable resistance device and wherein a resistance of the variable resistance device is controlled by the doorbell device.

5. The system of claim 4, wherein responsive to depression of the pushbutton, the doorbell device varies the resistance of the variable resistance device according to a known pattern.

6. The system of claim 5, further comprising a current sense resistor between the chime controller and the doorbell device.

7. The system of claim 6, wherein the chime controller is configured to detect the known pattern via current through the current sense resistor.

8. The system of claim 7, wherein the chime controller is configured to activate the chime in response to detecting the known pattern.

9. The system of claim 4, wherein the variable resistance device comprises a metal-oxide semiconductor field effect transistor (MOSFET).

10. The system of claim 1, wherein the chime controller comprises a voltage booster between the battery and the chime.

11. The system of claim 1, wherein the power source, the doorbell device, and the chime controller are connected in series.

12. The system of claim 1, wherein the power source and the chime controller are located inside a structure and the doorbell device is located outside the structure.

13. A system comprising:
a transformer for generating a power signal from a high voltage power source;
a doorbell device connected to the transformer, wherein the doorbell device comprises a camera, at least one sensor, and a pushbutton;
a chime controller connected to the transformer and to the doorbell device, the chime controller configured to activate a chime in response to depression of the pushbutton; and
circuitry associated with the doorbell device and configured to charge a supercapacitor using the power signal generated by the transformer while the chime is not activated, the supercapacitor configured to power the camera while the chime is activated.

14. The system of claim 13, wherein the circuitry comprises a charge controller for charging the supercapacitor.

15. The system of claim 14, wherein the circuitry further comprises a rectifier for rectifying the power signal from the transformer and a buck regulator for regulating a voltage of the rectified power signal.

16. The system of claim 14, wherein the circuitry further comprises a boost regulator for boosting a voltage of the supercapacitor.

17. The system of claim 13, wherein the at least one sensor is deactivated while the chime is activated.

18. A method of operating a smart doorbell system comprising a chime controller, a doorbell device, and a transformer connected in series, the method comprising:
providing at least one device in connection with the chime controller configured to providing a specified maximum voltage drop across the chime controller;
providing a variable resistance device having a resistance controllable by the doorbell device in series with the chime controller;
varying the resistance according to a known pattern in response to depression of a pushbutton of the doorbell device; and
detecting by the chime controller the varied resistance and activating a chime associated with the chime controller.

19. The method of claim 18, wherein the detecting is performed by detecting a current through a current sense resistor provided between the chime controller and the doorbell device.

20. The method of claim 18, wherein the at least one device comprises a pair of Zener diodes.
